(19) United States
(12) Patent Application Publication
(10) Pub. No.: US 2015/0089266 A1
(43) Pub. Date: Mar. 26, 2015

(54) SWITCH CIRCUIT AND COMPUTING DEVICE HAVING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: SONG MA, Shenzhen (CN); WU ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/227,256

(22) Filed: Mar. 27, 2014

(30) Foreign Application Priority Data
Sep. 23, 2013 (CN) 2013104341833

(51) Int. Cl. G06F 1/32; G06F 1/26

(52) U.S. Cl. CPC G06F 1/3287; G06F 1/266
USPC 713/324

(57) ABSTRACT

A computing device includes a display, a universal serial bus (USB) power source having a voltage output port to output a voltage to power input/output (I/O) devices connected to USB interfaces of the computing device, and a switch circuit connected between the display and the USB power source. The switch circuit can synchronously turn off the display and control the USB power source to stop outputting the voltage, and can synchronously turn on the display and control the USB power source to output the voltage.

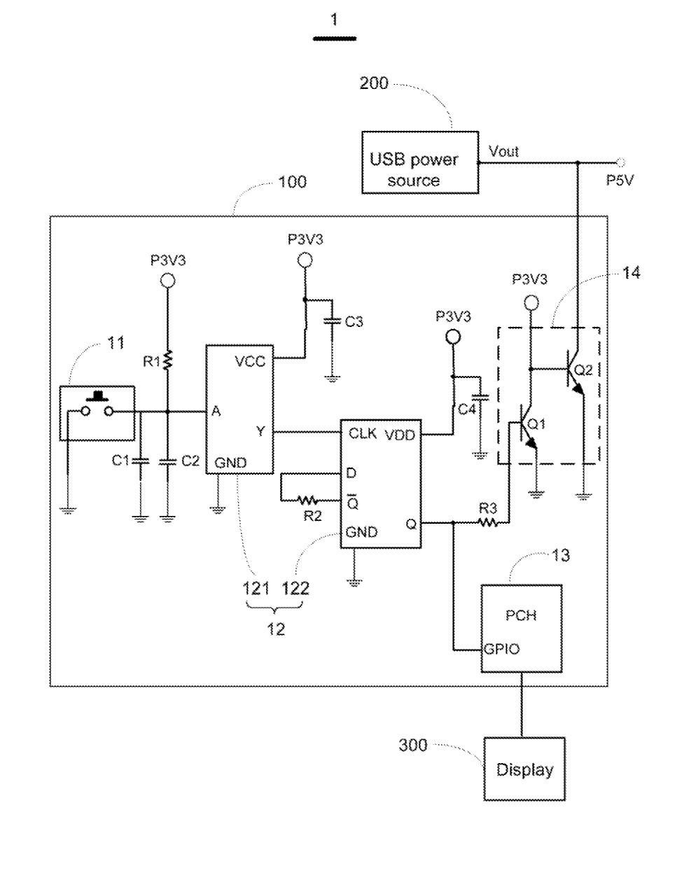

### FIELD

Embodiments of the present disclosure relate to switch circuits, and particularly to a switch circuit used in a computing device.

### BACKGROUND

A computing device can include a plurality of input/output (I/O) devices, such as a mouse, a keyboard, and a display, connected to universal serial bus (USB) interfaces of the computing device. When the computing device is not being used, the display of the computing device is usually turned off to reduce power consumption. However, the I/O devices, such as the mouse and the keyboard of the computing device, are still powered on to work normally when the display is turned off, which causes unnecessary waste of power. Therefore, there is room for improvement in the art.

### BRIEF DESCRIPTION OF THE DRAWINGS

The figure illustrates a schematic circuit diagram of one embodiment of a computing device including a switch circuit.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

Referring to the figure, a computing device 1 includes a switch circuit 100, a universal serial bus (USB) power source 200, and a display 300. The USB power source 200 includes a voltage output port (Vout) to output a voltage (e.g., 5V) to power input/output (I/O) devices (e.g., mouse and keyboard) connected to USB interfaces (not shown) of the computing device 100. The switch circuit 100 is electrically connected between the display 300 and the Vout of the USB power source 200. The switch circuit 10 controls the USB power source 200 to stop outputting the voltage when the display 300 is turned off. Thus, the I/O devices connected to the USB interfaces of the computing device 1 and powered by the USB power source 200 are turned off accordingly, thereby reducing unnecessary power waste of the I/O devices. The switch circuit 10 further controls the USB power source 200 to output the voltage when the display 300 is turned on. Thus, the I/O devices connected to the USB interfaces of the computing device 1 are turned on accordingly.

In this embodiment, the switch circuit 100 includes a power button 11, a signal generation unit 12, a platform control hub (PCH) 13, and a switch unit 14. The power button 11 is electrically connected to the signal generation unit 12. The signal generation unit 12 is electrically connected to a general purpose input output (GPIO) pin of the HUB 13 and an end of the switch unit 14. The other end of the switch unit 14 is electrically connected to the Vout of the USB power source 200. The PCH 13 is electrically connected to the display 300.

When the power button 11 is pressed, the power button 11 transmits a voltage signal to the signal generation unit 12. In this embodiment, one pin of the power button 11 is grounded. Therefore, the voltage signal is a low-level voltage signal (e.g., 0V) and is transmitted to the signal generation unit 12 when the power button 11 is pressed. In other embodiments, the power button 11 can be electrically connected to a power source (e.g., 3.3V) and the voltage signal can be a high-level voltage signal (e.g., 3.3V) accordingly.

When the signal generation unit 12 receives the voltage signal from the power button 11, the signal generation unit 12 generates and outputs a control signal to the PCH 13 and the switch unit 14. In this embodiment, the control signal includes a first control signal and a second control signal. For example, the first control signal can be a low-level signal such as logic “0,” and the second control signal can be a high-level signal such as logic “1.” The signal generation unit 12 generates the first control signal when the power button 11 is pressed an odd number of times, and generates the second control signal when the power button 11 is pressed an even number of times.

The PCH 13 turns off or turns on the display 300 according to the control signal received from the signal generation unit 12, and the switch unit 14 controls the USB power source 200 to output the voltage or not output the voltage according to the control signal. For example, when the control signal is the first control signal (e.g., the low-level signal), the PCH 13 turns off the display 300 and the switch unit 14 controls the USB power source 200 to stop outputting the voltage, thereby turning off the I/O devices powered by the USB power source 200. When the control signal is the second control signal (e.g., the high-level signal), the PCH 13 turns on the display 300 and the switch unit 14 controls the USB power source 200 to output the voltage to power the I/O devices.

In this embodiment, the PCH 13 is a south bridging chip of the computing device 1. The PCH 13 can be integrated on a motherboard (not shown) of the computing device 1. The PCH 13 controls the display 300 to output signals or not output signals by controlling a video card of the computing device 1.

The signal generation unit 12 includes a buffer 121 and a D trigger 122. The buffer 121 includes an input pin A, a ground pin GND, an output pin Y, and a first power pin VCC. The input pin A is electrically connected to the power button 11 to receive the voltage signal when the power button 11 is pressed. The input pin A is further electrically connected to a power source P3V3 (e.g., 3.3V) via a first resistor R1, to make the input pin be in a high-level state when the power button 11 is not pressed. When the power button 11 is pressed, the input pin A is pulled down to a low-level state. The output pin Y outputs the voltage signal (low-level voltage signal) received from the input pin A to the D trigger 122 after delaying a predetermined time duration (e.g., 100 ms). The first power pin VCC is electrically connected to the power source P3V3 to power the buffer 121. The ground pin GND is grounded.

The D trigger 122 includes a clock pin CLK, a second power pin VDD, a ground pin GND, a triggering pin D, an inverted output pin Q̅, and a noninverting output pin Q. The second power pin VDD is electrically connected to the power source P3V3 to supply power to the D trigger. The ground pin GND is grounded. The clock pin CLK is electrically connected to the output pin Y of the buffer 121 to receive the voltage signal. The triggering pin D is electrically connected to the inverted output pin Q̅ in series via a second resistor R2. When the clock pin CLK receives the voltage signal from the output pin Y, a signal output by the noninverting output pin Q is inverted. The inverted signal is the control signal, and the control signal is output to the PCH 13 and the switch unit 14. In this embodiment, the D trigger is a trailing edge trigger.

The switch unit 14 includes a first transistor Q1 and a second transistor Q2. Each of the first transistor Q1 and the second transistor Q2 includes a base, an emitter, and a collector. The base of the first transistor Q1 is electrically connected to the noninverting output pin Q of the D trigger 122 via a third resistor R3, the collector of the first transistor Q1 is electrically connected to the power source P3V3, and the emitter of the first transistor Q1 is grounded. The base of the second transistor Q2 is electrically connected to the collector of the first transistor Q1, the collector of the second transistor Q2 is electrically connected to the Vout of the USB power source 200, and the emitter of the second transistor Q2 is grounded.

When the control signal output from the D trigger 122 is the first control signal (e.g., the low-level signal), the base of the first transistor Q1 is pulled down to turn off the first transistor Q1, so that the base of the second transistor Q2 receives a voltage from the power source to turn on the second transistor Q2. When the second transistor Q2 is turned on, the USB power source 200 is grounded via the second transistor Q2, so that the USB power source 200 stops outputting the voltage via the Vout.

When the control signal output from the D trigger 122 is the second control signal (e.g., the high-level signal), the base of first transistor Q1 is pulled up to turn on the first transistor Q1, so that the base of the second transistor Q2 is grounded via the first transistor Q1 to turn off the second transistor Q2. When the second transistor Q2 is turned off, the USB power source 200 is not grounded via the second transistor Q2. Thus, the USB power source 200 can output the voltage via the Vout to power the I/O devices.

In this embodiment, capacitors C1, C2, C3, and C4, which are electrically connected between the power source and ground, are voltage stabilizing capacitors.

As described above, the switch circuit 100 can synchronously turns off the display 300 and other I/O devices of the computing device. Thus, power is prevented from being wasted by the I/O devices when the display 300 is turned off.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A switch circuit of a computing device, the computing device comprising a universal serial bus (USB) power source and a display, the USB power source comprising a voltage output port to output a voltage to power I/O devices connected to USB interfaces of the computing device, wherein:
the switch circuit is electrically connected between the display and the USB power source, the switch circuit is configured to synchronously turn off the display and control the USB power source to stop outputting the voltage, and to synchronously turn on the display and control the USB power source to output the voltage.

2. The switch circuit according to claim 1, comprising a power button, a signal generation unit, a platform control hub (PCH), and a switch unit, the power button being electrically connected to the signal generation unit, the signal generation unit being electrically connected to the HUB and an end of the switch unit, the other end of the switch unit being electrically connected to the voltage output port of the USB power source, and the PCH being electrically connected to the display, wherein:
the power button transmits a voltage signal to the signal generation unit when the power button is pressed;
the signal generation unit generates and outputs a control signal to the PCH and the switch unit, when the voltage signal is received;
the PCH turns off or turns on the display according to the control signal; and
the switch unit controls the USB power source to output the voltage or not output the voltage according to the control signal.

3. The switch circuit according to claim 2, wherein the power button is electrically connected to a ground and transmits a low-level voltage signal to the signal generation unit when the power button is pressed.

4. The switch circuit according to claim 2, wherein the control signal comprises a first control signal and a second control signal; the signal generation unit generates the first control signal when the power button is pressed an odd number of times, and generates the second control signal when the power button is pressed an even number of times.

5. The switch circuit according to claim 4, wherein when the first control signal is generated, the PCH turns off the display and the switch unit controls the USB power source to stop outputting the voltage via the voltage output port according to the first control signal; when the second control signal is generated, the PCH turns on the display and the switch unit controls the USB power source to output the voltage via the voltage output port.

6. The switch circuit according to claim 4, wherein the signal generation unit comprises a buffer and a D trigger, the buffer comprises an input pin and an output pin Y, the input pin is electrically connected to the power button to receive the voltage signal when the power button is pressed and connected to a power source via a first resistor; when the power button is pressed, the output pin outputs the voltage signal received from the input pin to the D trigger after delaying a predetermined time duration.

7. The switch circuit according to claim 6, wherein the D trigger comprises a clock pin, a triggering pin, an inverted output pin, and a noninverting output pin, the clock pin is electrically connected to the output pin of the buffer to receive the voltage signal, the triggering pin is electrically connected to the inverted output pin in serial via a second resistor; when the clock pin receives the voltage signal from the input pin, a signal output by the noninverting output pin Q is inverted, and the inverted signal is the control signal and is output to the PCH and the switch unit.

8. The switch circuit according to claim 7, wherein the switch unit comprises a first transistor and a second transistor, each of the first transistor and the second transistor comprises a base, an emitter, and a collector; the base of the first transistor is electrically connected to the noninverting output pin of the D trigger via a third resistor, the collector of the first transistor is electrically connected to a power source, and the emitter of the first transistor is grounded; the base of the second transistor is electrically connected to the collector of the first transistor, the collector of the second transistor is electrically connected to the voltage output port of the USB power source, and the emitter of the second transistor is grounded.

9. The switch circuit according to claim 8, wherein when the control signal output from the D trigger is the first control signal, the first transistor is turned off by the first control signal, the base of the second transistor receives a voltage from the power source to turn on the second transistor; when the second transistor is turned, the USB power source is grounded via the second transistor, so that the USB power source stops outputting the voltage via the voltage output port.

10. The switch circuit according to claim 8, wherein when the control signal output form the D trigger is the second control signal, the first transistor is turned on by the second control signal, so that the base of the second transistor is grounded via the first transistor to turn off the second transistor; when the second transistor is turned off, the USB power source is not grounded via the second transistor and outputs the voltage via the voltage output port.

11. A computing device, comprising:
a display;
a universal serial bus (USB) power source comprising a voltage output port to output a voltage to power I/O devices connected to USB interfaces of the computing device; and
a switch circuit connected between the display and the USB power source, wherein the switch circuit is configured to synchronously turn off the display and control the USB power source to stop outputting the voltage, and to synchronously turn on the display and control the USB power source to output the voltage.

12. The computing device according to claim 11, wherein the switch circuit comprises a power button, a signal generation unit, a platform control hub (PCH), and a switch unit; the power button is electrically connected to the signal generation unit, the signal generation unit is electrically connected to the HUB and an end of the switch unit, the other end of the switch unit is electrically connected to the voltage output port of the USB power source, and the PCH is electrically connected to the display; the power button transmits a voltage signal to the signal generation unit when the power button is pressed; the signal generation unit generates and outputs a control signal to the PCH and the switch unit, when the voltage signal is received; the PCH turns off or turns on the display according to the control signal; and the switch unit controls the USB power source to output the voltage or not output the voltage according to the control signal.

13. The computing device according to claim 12, wherein the power button is electrically connected to a ground and transmits a low-level voltage signal to the signal generation unit when the power button is pressed.

14. The computing device according to claim 12, wherein the control signal comprises a first control signal and a second control signal; the signal generation unit generates the first control signal when the power button is pressed an odd number of times, and generates the second control signal when the power button is pressed an even number of times.

15. The computing device according to claim 14, wherein when the first control signal is generated, the PCH turns off the display and the switch unit controls the USB power source to stop outputting the voltage via the voltage output port according to the first control signal; when the second control signal is generated, the PCH turns on the display and the switch unit controls the USB power source to output the voltage via the voltage output port.

16. The computing device according to claim 14, wherein the signal generation unit comprises a buffer and a D trigger, the buffer comprises an input pin and an output pin, the input pin is electrically connected to the power button to receive the voltage signal when the power button is pressed and connected to a power source via a first resistor; when the power button is pressed, the output pin outputs the voltage signal received from the input pin to the D trigger after delaying a predetermined time duration.

17. The computing device according to claim 16, wherein the D trigger comprises a clock pin, a triggering pin, an inverted output pin, and a noninverting output pin, the clock pin is electrically connected to the output pin of the buffer to receive the voltage signal, the triggering pin is electrically connected to the inverted output pin in series via a second resistor; when the clock pin receives the voltage signal from the input pin, a signal output by the noninverting output pin Q is inverted, and the inverted signal is the control signal and is output to the PCH and the switch unit.

18. The computing device according to claim 17, wherein the switch unit comprises a first transistor and a second transistor, each of the first transistor and the second transistor comprises a base, an emitter, and a collector; the base of the first transistor is electrically connected to the noninverting output pin of the D trigger via a third resistor, the collector of the first transistor is electrically connected to a power source, and the emitter of the first transistor is grounded; the base of the second transistor is electrically connected to the collector of the first transistor, the collector of the second transistor is electrically connected to the voltage output port of the USB power source, and the emitter of the second transistor is grounded.

19. The computing device according to claim 18, wherein when the control signal output from the D trigger is the first control signal, the first transistor is turned off by the first control signal, the base of the second transistor receives a voltage from the power source to turn on the second transistor; when the second transistor is turned, the USB power source is grounded via the second transistor, so that the USB power source stops outputting the voltage via the voltage output port.

20. The computing device according to claim 18, wherein when the control signal output form the D trigger is the second control signal, the first transistor is turned on by the second control signal, so that the base of the second transistor is grounded via the first transistor to turn off the second transistor; when the second transistor is turned off, the USB power source is not grounded via the second transistor and outputs the voltage via the voltage output port.
